(19) United States
(12) Patent Application Publication
(10) Pub. No.: US 2026/0295536 A1
(43) Pub. Date: Oct. 1, 2026

(54) GAS SEPARATION MEMBRANE MODULE

(71) Applicant: HONDA MOTOR CO., LTD., Tokyo (JP)

(72) Inventor: Yuki Shibahata, Wako-shi (JP)

(21) Appl. No.: 19/551,642

(22) Filed: Feb. 27, 2026

(30) Foreign Application Priority Data
Mar. 27, 2025 (JP) 2025-053215

(51) Int. Cl. B01D 63/08; B01D 53/22; B01D 65/00; B01D 69/06; B01D 69/12

(52) U.S. Cl. CPC B01D 63/082; B01D 53/228; B01D 65/003; B01D 69/06; B01D 69/12; B01D 2313/042; B01D 2313/08; B01D 2319/02

(57) ABSTRACT

Provided is a gas separation membrane module in which a plurality of flat gas separation membranes are stacked, raw material gas flow paths and separation membrane permeate gas flow paths are alternately disposed, and the raw material gas flow paths and the separation membrane permeate gas flow paths are oriented approximately perpendicular to each other, wherein a liquid seal is filled in a space between corner portions of the gas separation membrane and holding members that hold each of the corner portions of the gas separation membrane from an outer corner side.

### CROSS-REFERENCE TO RELATED APPLICATION

Priority is claimed on Japanese Patent Application No. 2025-053215, filed Mar. 27, 2025, the content of which is incorporated herein by reference.

### BACKGROUND OF THE INVENTION

### Field of the Invention

The present invention relates to a gas separation membrane module.

### Description of Related Art

Due to the use of fossil fuels such as oil and coal, exhaust gases emitted from factories contain carbon dioxide. From the perspective of carbon neutrality, it is desirable to reduce carbon dioxide emissions from factories. Methods for separating and capturing carbon dioxide contained in exhaust gases include, for example, an amine absorption method, a physical adsorption method, a membrane separation method, and the like. Among them, the membrane separation method using a gas separation membrane has attracted attention because of its low cost and ease of implementation.

In the membrane separation method, a vacuum pump is used to create a pressure difference between a front surface and a back surface of a gas separation membrane, thereby allowing carbon dioxide to selectively pass through. Because the membrane separation method does not require thermal energy, it can separate carbon dioxide at low cost.

As a gas separation membrane module used in the membrane separation method, there is known a configuration in which a plurality of gas separation membranes are stacked, raw material gas flow paths and membrane permeate gas flow paths are disposed alternately, and directions of the raw material gas flow paths and membrane permeate gas flow paths are approximately perpendicular to each other (refer to, for example, Japanese Unexamined Patent Application, First Publication No. 2004-33964).

### SUMMARY OF THE INVENTION

In the gas separation membrane module, it is necessary to separate the flow paths for a carbon dioxide-mixed gas (a FEED gas) and a suction gas (a PERM gas). In a typical method, a sealing material such as an O-ring is used to seal the flow path for the carbon dioxide-mixed gas and the flow path for the suction gas, thereby preventing the carbon dioxide-mixed gas and the suction gas from mixing. When a sealing material such as an O-ring is used, a groove or the like is required to accommodate the sealing material, which increases the overall thickness of the gas separation membrane module and makes it difficult to make the gas separation membrane module thinner.

An aspect of the present invention provides a gas separation membrane module in which a flow path for carbon dioxide-mixed gas and a flow path for suction gas are sealed without increasing the thickness. The aspect of the present invention contributes to energy efficiency.

The present invention has the following aspects.

[1] There is provided a gas separation membrane module in which a plurality of flat gas separation membranes are stacked, raw material gas flow paths and separation membrane permeate gas flow paths are alternately disposed, and the raw material gas flow paths and the separation membrane permeate gas flow paths are oriented approximately perpendicular to each other, wherein a liquid seal is filled into a space between corner portions of the gas separation membrane and holding members that hold each of the corner portions of the gas separation membrane from the outer corner side.

According to the above aspect, the gas separation membrane module can be realized in which the raw material gas flow path and the separation membrane permeate gas flow path are sealed without increasing a thickness. Furthermore, no structural partition is required between the raw material gas flow path and the separation membrane permeate gas flow path.

[2] In the gas separation membrane module of [1], a sealing material flow path that communicates with each of the corner portions of the gas separation membrane may be provided in the holding member, and the liquid seal may be filled in the sealing material flow path, and the liquid seal may hold each of the corners of the stacked gas separation membranes from the outer corner side.

According to the above aspect, the gas separation membrane module can be realized in which the raw material gas flow path and the separation membrane permeate gas flow path are sealed without increasing a thickness. Furthermore, no structural partition is required between the raw material gas flow path and the separation membrane permeate gas flow path.

[3] In the gas separation membrane module of [1] or [2], a notch may be formed in each of the corner portions of the gas separation membrane.

According to the above aspect, the liquid seal filled in the space between the corner portion of the gas separation membrane and the holding member from the sealing material flow path also is filled into the notch, thereby further improving sealing performance of the corner portion of the gas separation membrane.

[4] In the gas separation membrane module of [2], a boundary portion between the sealing material flow path and the space may have a fillet structure.

According to the above aspect, the liquid seal can be filled without a gap into the space between the corner portion of the gas separation membrane and the holding member via the sealing material flow path.

[5] In the gas separation membrane module of [2], a boundary portion between the sealing material flow path and the space may have a chamfered structure.

According to the above aspect, the liquid seal can be filled without a gap into the space between the corner portion of the gas separation membrane and the holding member via the sealing material flow path.

According to an aspect of the present invention, it is possible to provide a gas separation membrane module in which a flow path for carbon dioxide-mixed gas and a flow path for suction gas are sealed without increasing a thickness.

### BRIEF DESCRIPTION OF THE DRAWINGS

FIG. 1 is a plan view showing a gas separation membrane module according to one embodiment of the present invention.

FIG. 2 is a plan view showing a sealing material flow path formed in a holding member that constitutes the gas separation membrane module according to the embodiment of the present invention.

FIG. 3 is a plan view showing the sealing material flow path formed in the holding member constituting the gas separation membrane module according to the embodiment of the present invention.

FIG. 4 is a diagram showing results of simulating pressure in the sealing material flow path when a liquid sealing material is filled into a space between a corner portion of the gas separation membrane and the holding member through the sealing material flow path in example 1.

FIG. 5 is a diagram showing results of simulating pressure in the sealing material flow path when a liquid sealing material is filled into a space between a corner portion of the gas separation membrane and the holding member through the sealing material flow path in Example 2.

### DETAILED DESCRIPTION OF THE INVENTION

Hereinafter, an embodiment of the present invention will be described in detail with reference to the accompanying drawings.

### Gas Separation Membrane Module

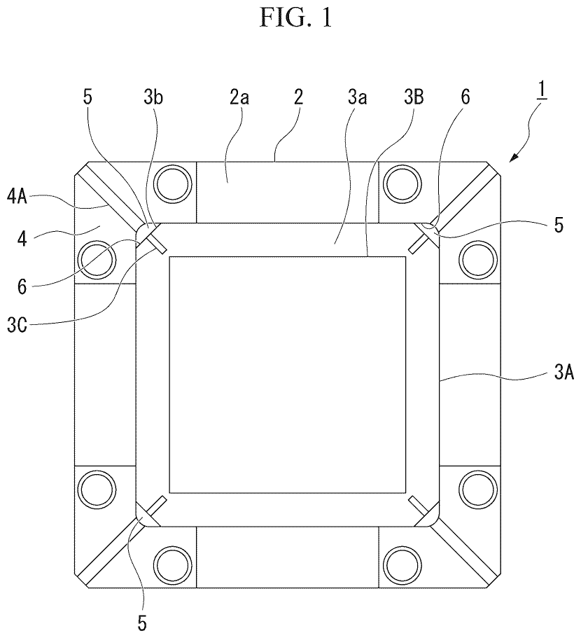

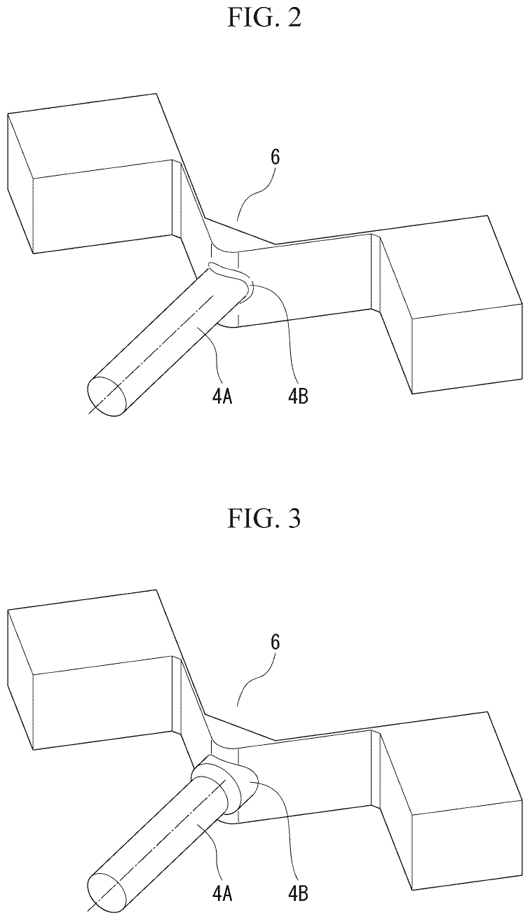

FIG. 1 is a plan view showing a gas separation membrane module according to one embodiment of the present invention. FIGS. 2 and 3 are plan views showing a sealing material flow path formed in a holding member that constitutes the gas separation membrane module according to the embodiment of the present invention.

As shown in FIG. 1, the gas separation membrane module 1 of this embodiment includes a module holder 2, a separation membrane substrate 3A, a gas separation membrane 3B, a holding member 4, and a liquid seal 5.

The gas separation membrane 3B is a flat gas separation membrane formed in a substantially rectangular flat plate shape. The gas separation membrane 3B is attached to one surface (a front surface) and the other surface (a back surface) of the separation membrane substrate 3A. The gas separation membrane 3B has a function of mainly allowing carbon dioxide contained in an exhaust gas to pass through. The gas separation membrane 3B is formed of an organic membrane that is mainly composed of an amino group and has a property of separating carbon dioxide from other gases using a solution-diffusion mechanism. As the gas separation membrane 3B, for example, an amino group-based organic membrane mainly made of polyamide, polyimide, or polysulfone can be used.

In the gas separation membrane module 1 of this embodiment, a plurality of separation membrane substrates 3A and gas separation membranes 3B are stacked on one surface (an upper surface) 2a of the module holder 2.

A plurality of flow path spacers (not shown) are disposed in one direction of one surface 3a of the gas separation membrane 3B (for example, a transverse direction of the gas separation membrane 3B) so as to be in contact with both surfaces of the gas separation membrane 3B. The plurality of flow path spacers are disposed on both surfaces of the gas separation membrane 3B at equal intervals in the transverse direction of the one surface 3a of the gas separation membrane 3B. By arranging the flow path spacers in this manner, first spaces (raw material gas flow paths) and second spaces (separation membrane permeate gas flow paths) are alternately disposed between two gas separation membranes 3B adjacent to each other in a stacking direction. The raw material gas flow path and the separation membrane permeate gas flow path are oriented substantially perpendicular to each other.

The holding members 4 hold corner portions of the gas separation membrane 3B, more specifically, four corner portions 3b of the separation membrane substrate 3A to which the gas separation membrane 3B is attached, from the outer corner side. A sealing material flow path 4A that communicates with each of the corner portions 3b of the separation membrane substrate 3A to which the gas separation membrane 3B is attached is provided in the holding member 4. The sealing material flow path 4A communicates with a space 6 between the holding member 4 and the corner portion 3b of the separation membrane substrate 3A to which the gas separation membrane 3B is attached. As shown in FIG. 2, a boundary portion 4B between the sealing material flow path 4A and the space 6 preferably has a fillet structure. The fillet structure is a structure in which edges and corners of the boundary portion 4B are rounded off. As shown in FIG. 3, the boundary portion 4B between the sealing material flow path 4A and the space 6 preferably has a chamfered structure. The chamfered structure is a structure in which sharp edges or corners of the boundary portion 4B are removed. By forming the boundary portion 4B into the fillet structure or the chamfered structure in this way, the liquid seal 5 can be filled into the space 6 without a gap through the sealing material flow path 4A.

The liquid seal 5 is filled in a space between the holding members 4 that hold each of the corner portions 3b of the separation membrane substrate 3A, to which the gas separation membrane 3B is attached, from the outer corner side. The liquid seal 5 is filled in the sealing material flow path 4A, and holds each of the corner portions 3b of the stacked gas separation membranes 3B from the outer corner sides. The liquid seal 5 is not particularly limited, but for example, one-component room temperature curing silicone or the like can be used.

In the gas separation membrane module 1 of this embodiment, it is preferable that a notch 3C extending from the corner portion 3b toward an inner region of the gas separation membrane 3B be formed in the corner portion 3b of the separation membrane substrate 3A to which the gas separation membrane 3B is attached. Thus, the liquid seal 5 filled into the space 6 from the sealing material flow path 4A is also filled into the notch 3C, thereby improving sealing performance of the corner portion 3b of the separation membrane substrate 3A to which the gas separation membrane 3B is attached.

According to the gas separation membrane module 1 of this embodiment, the raw material gas flow path and the separation membrane permeate gas flow path can be sealed without increasing the thickness, and a structural partition between the raw material gas flow path and the separation membrane permeate gas flow path is not required.

Although the embodiment of the present invention has been described in detail above, the present invention is not limited to the above embodiment, and various modifications and changes are possible within the scope of the gist of the present invention as described in the claims.

### EXAMPLES

The present invention will be described in more detail below with reference to examples, but the present invention is not limited to the following examples.

### Example 1

In the gas separation membrane module, the boundary portion between the corner portion of the gas separation membrane and the space between the holding members in the sealing material flow path of the holding member has a fillet structure.

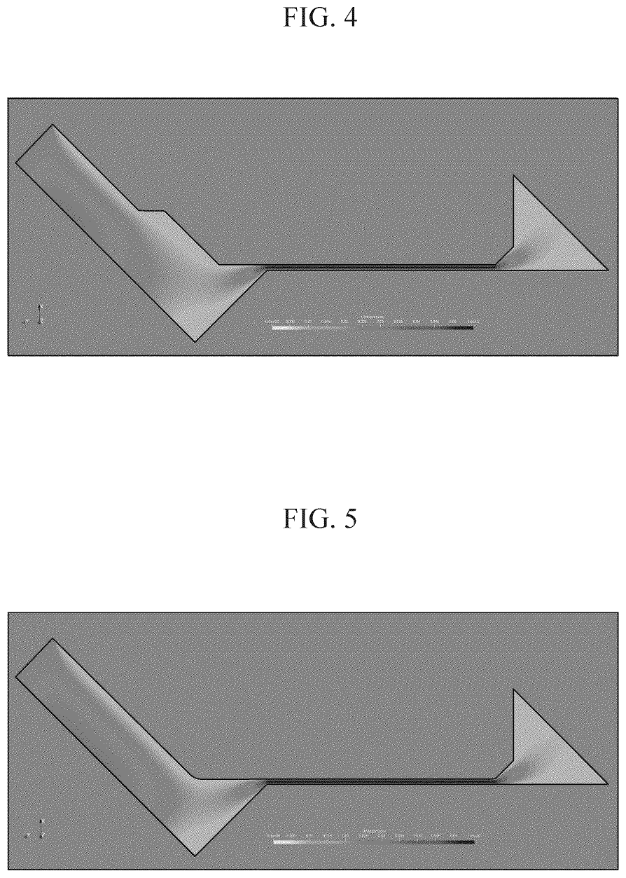

Pressure inside the sealing material flow path was simulated when a liquid sealing material was filled into the space through the sealing material flow path. A simulation method and conditions were set as follows: a liquid gasket viscosity and an inflow velocity were set as inlet boundary conditions, and pressure was set as an outlet boundary condition. Results thereof are shown in FIG. 4. In FIG. 4, the liquid sealing material flows from left to right in the drawing. An indicator shown in FIG. 4 indicates the pressure in the sealing material flow path, and the pressure increases toward the right.

### Example 2

In the gas separation membrane module, the boundary portion between the corner portion of the gas separation membrane and the space between the holding members in the sealing material flow path of the holding member has a chamfered structure.

Pressure inside the sealing material flow path was simulated when a liquid sealing material was filled into the space through the sealing material flow path. A simulation method and conditions were set as follows: a liquid gasket viscosity and an inflow velocity were set as inlet boundary conditions, and pressure was set as an outlet boundary condition. Results thereof are shown in FIG. 5. In FIG, 5, the liquid sealing material flows from left to right on the drawing. An indicator shown in FIG. 5 indicates the pressure in the sealing material flow path, and the pressure increases toward the right.

From the results shown in FIGS. 4 and 5, no significant difference was observed in the pressure inside the sealing material flow path between the fillet structure and the chamfered structure.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A gas separation membrane module in which a plurality of flat gas separation membranes are stacked, raw material gas flow paths and separation membrane permeate gas flow paths are alternately disposed, and the raw material gas flow paths and the separation membrane permeate gas flow paths are oriented approximately perpendicular to each other,
wherein a liquid seal is filled in a space between corner portions of the gas separation membrane and holding members that hold each of the corner portions of the gas separation membrane from an outer corner side.

2. The gas separation membrane module according to claim 1, wherein a sealing material flow path that communicates with each of the corner portions of the gas separation membrane is provided in the holding member, and
the liquid seal is filled in the sealing material flow path, and the liquid seal holds each of the corners of the stacked gas separation membranes from the outer corner side.

3. The gas separation membrane module according to claim 1, wherein a notch is formed in each of the corner portions of the gas separation membrane.

4. The gas separation membrane module according to claim 2, wherein a boundary portion between the sealing material flow path and the space has a fillet structure.

5. The gas separation membrane module according to claim 2, wherein a boundary portion between the sealing material flow path and the space has a chamfered structure.
